(19) United States
(12) Patent Application Publication
(10) Pub. No.: US 2010/0219143 A1
(43) Pub. Date: Sep. 2, 2010

(54) X stand keyboard dolly

(76) Inventor: Bruce Poston McCleave, Portland, OR (US)

Correspondence Address: Bruce Poston McCleave, 2400 S.W. Kanan St. #A, Portland, OR, 47239, US

(21) Appl. No.: 12/656,199

(22) Filed: Jan. 19, 2010

Related U.S. Application Data
(60) Provisional application No. 61/205,702, filed on Jan. 20, 2009.

(51) Int. Cl. F16M 11/38; F16D 65/14

(52) U.S. Cl. 211/85.8; 188/1.12

(57) ABSTRACT

A dolly design and structure that attaches to a single or double tiered X stand type keyboard stand as well as, or alternatively, other loads including other types of musical staging backline with or without accessories and can support the fully loaded keyboard stand and/or accessories while allowing quick and easy maneuverability in tight places. This dolly design incorporates adjustments and locking mechanisms to allow for safe and secure means for holding an X stand keyboard stand in place on said dolly. This newly added feature of mobility for a keyboard setup utilizing an X stand keyboard dolly provides the user with the valuable added feature of quick and easy maneuverability, in tight places, of the complete keyboard setup as needed—while the keyboard setup stays relatively intact. This will be an invaluable new asset to users that utilize the X stand keyboard dolly in their keyboard setups.

### CROSS-REFERENCE TO RELATED APPLICATIONS

This application claims priority to provisional application No. 61/205,702 filed on Jan. 20, 2009.

### FEDERALLY SPONSORED RESEARCH

None

### SEQUENCE LISTING

None

### BACKGROUND

This relates to dollies, specifically a dolly that supports a type of keyboard stand commonly referred to in the music and entertainment business as an “X stand”. A production item that may be used in the music and entertainment business is commonly referred to as a musical staging backline item. An “X stand” type keyboard stand is a musical staging backline item. The dolly I will be discussing below is an adjustable dolly structure designed to add mobility to a single or double tiered X stand type keyboard stand and/or other loads including other types of musical staging backline and/or accessories. Musical Staging is the part of the Music Business that involves many key dynamics of moving and placing of the physical items being used at any given time on a stage or any related setting that utilizes musical gear. Being a long time veteran and production manager in the Music and Entertainment Business, it has become very clear that there is much room for improvements and development of gear throughout the Music Industry. This can become a very important component as it is often directly related to the bottom line or overall cost of doing business on a production that depends on handling, moving, and or repositioning of larger musical related items. I have been involved in many productions where many larger items such as complete keyboard setups, guitar amps, bass amps, etc, were needed to be moved quickly and repositioned on or off a stage or elsewhere. It became obvious that lack of mobility and other factors can easily cause problems, slow things down, or otherwise cause problematic issues to those involved.

The need for this kind of dolly becomes very obvious when we think about a major television award show such as “The Grammy Award Show” where producers have, for example, two hours real time to put many acts on and off a stage quickly. This could easily be a situation where producers need to move, for example, seven large live bands and eight smaller DJ—Front man type acts on and off a stage in real time for a national television show. This kind of show costs many thousands of dollars per minute to produce and we can now see where it becomes very important to execute a high paced choreography and ballet of moving around many major pieces of musical related items quickly and safely. This is why my new dolly design would be a benefit to producers, musicians, technicians, and others throughout the music and entertainment business. There are many potential new benefits for the musician user of this dolly design and backline setup including a user having a new freedom of mobility over previously used stationary backline setups, and potentially inspiring more creativity and new ideas on how to utilize a mobile keyboard setup or other appropriate backline setup or load. There is a constant need to keep up with developments in technology within the music and entertainment industry. This is why I have designed this new keyboard dolly. This dolly structure is specifically designed to improve many aspects of working with a single or double tiered X stand type keyboard stand as well as, or alternatively, other loads including other types of musical staging backline with or without accessories. This dolly will decrease the amount of time and effort involved when moving a keyboard setup or other load that utilizes this musical staging backline and dolly combination. Situations as mentioned above make it very apparent why this new dolly design is needed for keyboard players, various types of musicians, producers, technicians, and other users that may utilize the single or double tiered X stand type keyboard stand as well as, or alternatively, other loads including other types of musical staging backline with or without accessories.

Both U.S. Pat. No. D289,952 to Rokkomann (1987) and U.S. Pat. No. D4,763,865 to Danner (1988) show a keyboard stand representing what is commonly referred to as an “X stand” type keyboard stand throughout the music industry. This type of keyboard stand has been very popular since it was introduced to the market over twenty years ago. This keyboard stand, even though very popular, has limitations. One major limitation of the X stand is once this type of keyboard stand is loaded with keyboards or other accessories—it has to stay where it is. The keyboard stand and setup cannot be moved easily. If a move is required it would most likely involve disassembling the keyboard setup significantly to facilitate the move. To move this complicated setup once it has been put together can be very problematic and time consuming. It could easily involve un-patching many cables and removing the keyboard items to make the move possible. This new dolly is designed to eliminate this kind of hassle and add a new means of mobility to the average single or double tiered X stand type keyboard stand as well as, or alternatively, other loads including other types of musical staging backline with or without accessories. Making this kind of keyboard stand a mobile item adds new functionality, style, mode of operation, as well as other positive benefits to the keyboard stand's usefulness. The dolly structure is designed to handle many brands and designs of the popular X stand series of keyboard stands, specifically, as well as other types of musical staging backline items, generally, and or other loads. This popular type of keyboard stand is currently sold by companies such as Proline—Thousand Oaks, California—www.prolinestands.com, and On-Stage Stands—Berlin, Connecticut—www.onstagestands.com and many others. The X stand type of keyboard stand and many other backline items are used everyday in situations that can easily benefit from using this new dolly design. This new dolly design will spur new ideas for the user helping them use their complete keyboard setup or other type backline setup more creatively.

In conclusion, insofar as I am aware, no dolly structure formerly developed provides a unique platform to securely attach and carry a loaded single or double tiered X stand type keyboard stand as well as, or alternatively, other loads including other types of musical staging backline with or without accessories, and thus provide quick and easy maneuverability for the user and the complete desired musical staging backline setup.

### SUMMARY

An improved use of a popular type of keyboard stand as well as, or alternatively, other loads including other types of musical staging backline with or without accessories by incorporating a unique dolly structure that has design features specifically tailored to holding, supporting, and carrying a complete “X stand” type keyboard stand setup as well as, or alternatively, other musical staging backline loads—thus allowing easy multi-directional mobility of the entire backline setup while keeping the setup significantly more intact—and thus a significant improvement over what would be the case of immobility of the entire backline setup without such a dolly structure. The dolly is designed to install and uninstall quickly and easily to a single or double tiered X stand type keyboard stand as well as, or alternatively, other loads including other types of musical staging backline with or without accessories that fit within the dolly load and size capacity specifications. This dolly design adds a new means of mobility and other advantages to what would otherwise be an immobile and stationary X stand type keyboard set or other stationary type musical staging setup. The dolly also has design features that provide a means for adjustment to accommodate any height angle the X stand is designed to handle. Used properly the dolly can support the manufacturer's full load capacity for the single or double tiered X stand type keyboard stand as well as, or alternatively, other loads including other types of musical staging backline with or without accessories while providing a means of mobility—with lockdown capability at a desired location. This dolly design can be used with many single tiered or double tiered, light duty, and heavy duty type X stand keyboard stands and other loads. Some single or double tiered X stand type keyboard stands as well as, or alternatively, other loads including other types of musical staging backline with or without accessories may not fit the dolly structure correctly and are not recommended to be used with this dolly.

This new approach to an X stand type keyboard stand setup and or other type musical staging backline setup—mainly the ability to easily move or reposition the X stand type keyboard stand's footprint as needed—adds value, style, and new functionality for the user that utilizes this new dolly design in a backline setup. This will be an invaluable improvement for stage technicians, musicians, and producers who often utilize the single or double tiered X stand type keyboard stand as well as, or alternatively, other loads including other types of musical staging backline with or without accessories on a daily basis for their musical staging needs. Many advantages of my new dolly design will become apparent from a study of the following description and the accompanying drawings.

### DRAWINGS

FIG. 1 is a drawing representing the front view of a loaded X stand attached to an X stand keyboard dolly.

FIG. 2 is a drawing representing an exploded front view of a keyboard setup showing how the load and X stand are situated on the X stand dolly.

FIG. 3 is a front view drawing from the top representing a single X stand dolly without any keyboard stand attached.

FIG. 4 is a drawing representing the side view of an X stand keyboard dolly separated into two pieces.

FIG. 5 is a drawing representing the top view of one support beam of an X stand keyboard dolly.

FIG. 6 is a drawing representing a clamping mechanism on one side of the X stand dolly support beam showing the clamping mechanism holding an X stand foot rail in place.

FIG. 7 is a drawing representing the end view of one support beam showing a wheel and wheel support bracket attached to said support beam.

### DETAILED DESCRIPTION

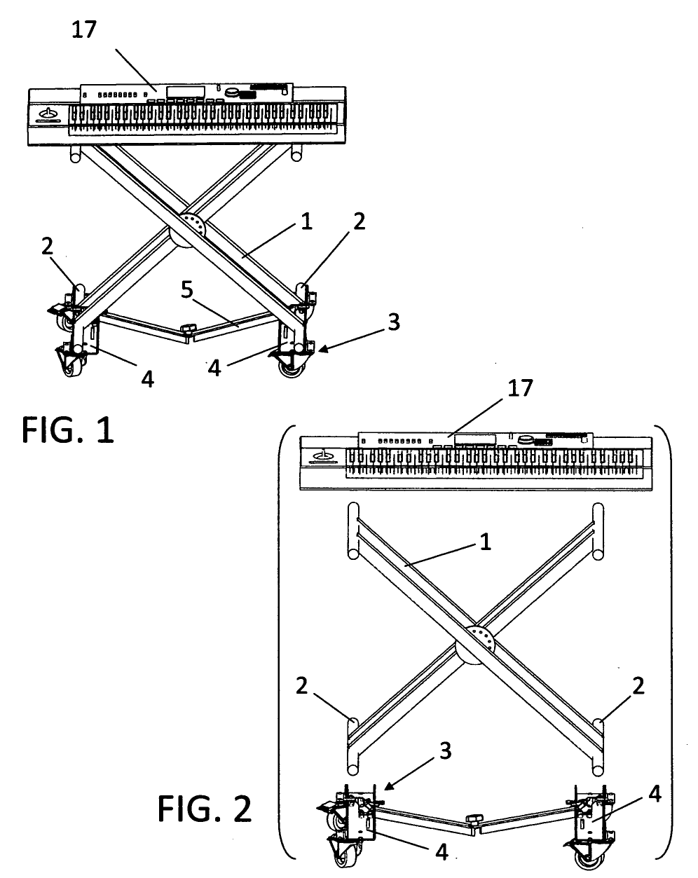

FIG. 1 is a front view representing a complete keyboard setup. This FIG. shows a load 17 on top of an X stand 1 that is attached to an assembled X stand keyboard dolly 3. The foot rails 2 of the X stand are held in position on the support beams 4 of the dolly structure. There is a small adjustable beam section 5 operably coupling the two support beams together—adding further stability to the dolly structure.

FIG. 2 is an exploded view of a complete keyboard setup showing how the keyboard load 17 and the X stand 1 are positioned on top of the X stand dolly 3. The X stand foot rails 2 align and drop into place on the dolly support beams 4 and are then locked into place.

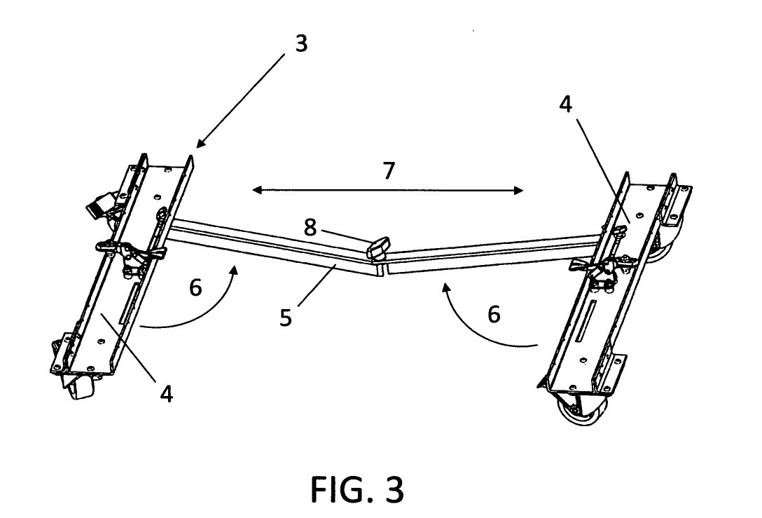

FIG. 3 is a top view from the front representing the X stand dolly. The adjustable beam section 5 has a telescoping design 7 with a clinching mechanism 8 to hold the adjustment. The adjustable beam section in this embodiment is also pivotable 6 and pivots from the support beams 4 operably joining two halves of said dolly together at the center. This allows for lateral adjustment and further stability to the support beam structure. The dolly, as embodied in this example drawing, has a two piece structure that assembles into a one piece structure—and installs or uninstalls to an empty X stand or other appropriate load quickly and easily. The dolly structure is now ready for the user to load an X stand type keyboard stand as well as, or alternatively, other loads.

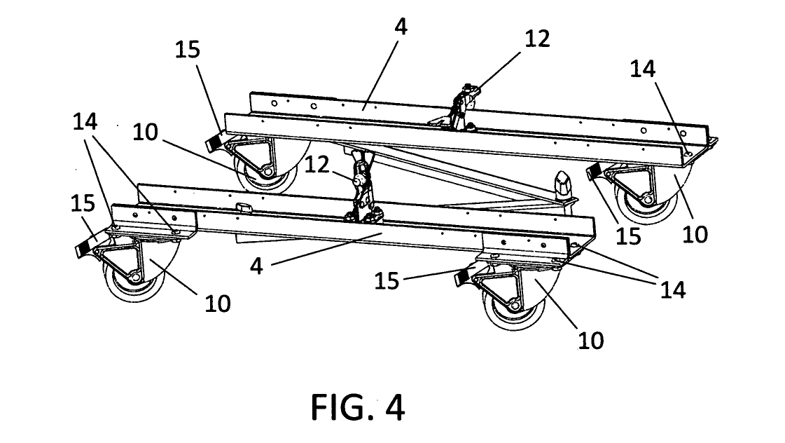

FIG. 4 is a side view representing one X stand keyboard dolly structure separated into two support beam 4 sections positioned side by side. The two support beams comprising of aluminum channel, or other appropriate material substantial enough to handle the load, that are cut to an equal length large enough to support the length and width of the average X stand type keyboard stand foot rail. Installed near the center of each support beam is a clamping mechanism 12 that is used to hold the X stand keyboard stand and/or other load in place on the support beam structure. There are two swiveling, locking, rubberized, heavy duty wheels 10 attached to each of the support beams by means of a bolt and nut assembly 14 or other permanent attachment application in this embodiment. There are four wheels total in this embodiment. The wheel braking lever is in the locked 15 position on all four wheels in this drawing.

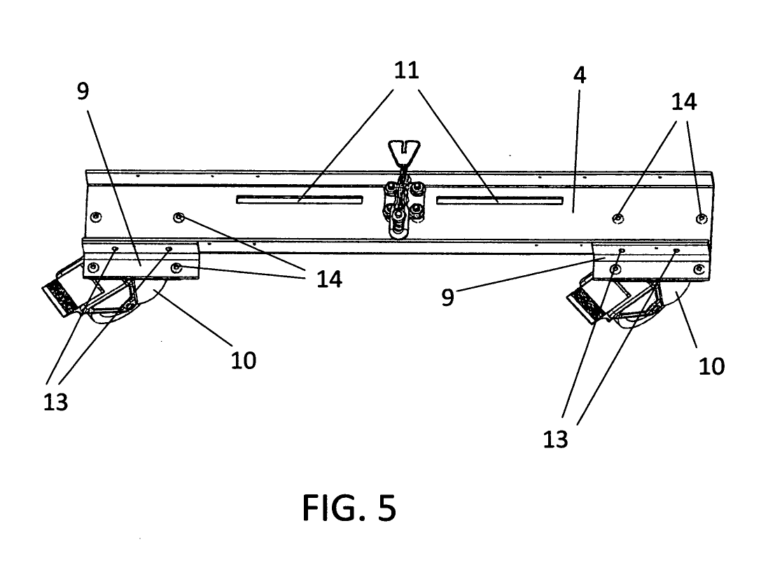

FIG. 5 is a top view representing one side of the X stand keyboard dolly support beam 4 showing two wheels 10 attached to the support beam by means of bolts and nuts 14, or other permanent means. The wheel support brackets 9 are attached to the ends of the support beam by rivets 13, or other permanent means. The wheel support brackets comprising of left over aluminum channel, or other appropriate material, and are attached to the outside ends of each of the two support beams. This makes a total of four wheel support brackets for this embodiment. The dolly support beam has small slots 11 for the positioning of the adjustable beam section and/or other accessories enabling alignment to accommodate many various X stand dolly configurations.

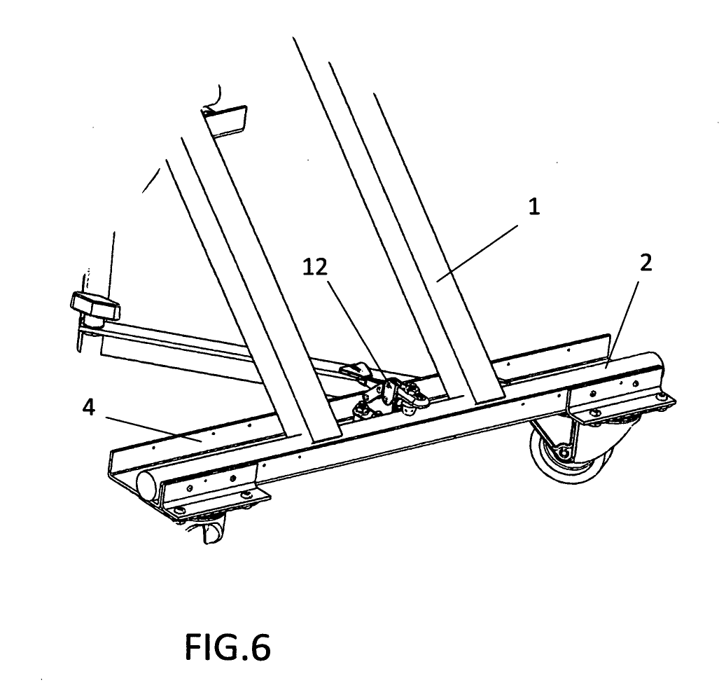

FIG. 6 is a close up drawing representing a clamping mechanism coupled to support beam 4 showing a clamping mechanism 12 holding the X stand 1 securely in place. There may be a clamping mechanism on each main rail. Once the X stand is set in place, the user must close the clamping mechanism to secure the X stand foot rail 2 to the dolly support beam. This procedure is duplicated on the opposite side support beam and thus secures the keyboard stand evenly in place on the dolly.

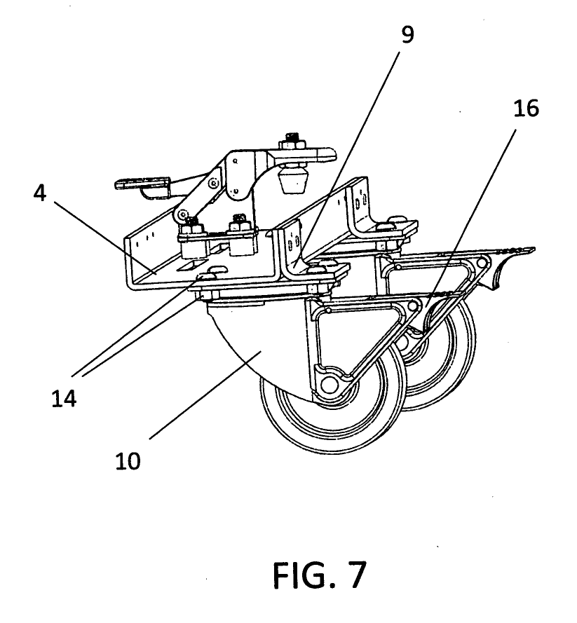

FIG. 7 is a drawing representing one support beam 4 of the dolly from the end view. This view shows an embodiment including one flat surface (back) of the wheel support bracket 9 attached to a support beam and the other side of the wheel support bracket (bottom) is attached to a wheel 10. The bottom of each wheel support bracket may be attached to each wheel by means of a bolt and nut assembly 14 or other permanent application. This figure also shows one swiveling, locking, rubberized, heavy duty wheel in the unlocked position 16.

### REFERENCE NUMERALS

1. X stand keyboard stand
2. X stand keyboard stand foot rail
3. X stand keyboard dolly
4. X stand keyboard support beam
5. Adjustable beam section
6. Pivotable design for center brace
7. Telescoping design for center brace
8. Clinching mechanism
9. Wheel support brackets
10. Swiveling, locking, rubberized, heavy duty wheels
11. Slots
12. Clamping mechanism
13. Rivets
14. Bolt and nut assembly
15. Wheel braking lever—locked position
16. Wheel braking lever—unlocked position
17. Normal load (for X stand type keyboard stand)

### Operation

In operation one uses the complete keyboard setup in a normal manner including having the desired keyboards placed in position and the power cables, patch cables and all accessories attached. This is the normal load 17 for the keyboard stand 1 FIG. 1. When the X stand is utilized in conjunction with the X stand keyboard dolly 11 improvements increase the X stand's usability for the user:
1) An X stand type keyboard stand 1 when attached and used properly with an X stand keyboard dolly 3 has a newly added feature of mobility FIG. 1
2) This added feature is present because the dolly structure has attached a means of mobility such as wheels 10. FIG. 4.
3) These added wheels have a means of braking 15 to allow for secure lockdown of the dolly at a desired location. FIG. 4.
4) These added wheels have a means of un-braking 16 allowing the user to quickly transition from a stationary mode to mobile mode. FIG. 7.
5) This dolly structure has a means of holding 12 an X stand type keyboard stand securely in place under load conditions. FIG. 6.
6) A means of adjusting 5 to align and accommodate for the keyboard stand's many adjustment angles—while maintaining a level base FIG. 3.
7) A quick and easy move is facilitated allowing for better time management of the user—as the user would have to partially or totally disassemble the keyboard setup if the setup did not include an X stand keyboard dolly.
8) A user can be more creative in using the keyboard setup during a show, a teaching session, or other related situation.
9) A user can increase the safety of his or her gear—as the gear will have to be mounted and dismounted less often in order to help facilitate a move while using an X stand keyboard dolly.
10) A user can more efficiently utilize manpower as there is less physical effort involved to facilitate a move of the complete keyboard setup while using an X stand keyboard dolly.
11) The dolly structure in this embodiment can separate into two smaller members, or shrink down to a minimal size for ease of transportation and storage. FIG. 4.

The invention claimed is:

1) A small multi wheeled, stable, utility dolly for tasks including supporting and carrying a single or double tiered X stand type keyboard stand as well as, or alternatively, other loads including other types of musical staging backline with or without accessories accessories, comprising;
a) a support beam or beams having a length or lengths and a width or widths, and
b) at least three wheels widely spaced apart mounted to freely swivel, and
c) an extending beam or beams pivotally coupled to a side or sides of said support beam for supporting material and/or for pivotally coupling one or more beams, and
d) a clamping mechanism being removably coupled to said support beam for holding in place said single or double tiered X stand type keyboard stand on said support beam whereby; said utility dolly can be configured to hold down and carry said single or double tiered X stand type keyboard stand as well as, or alternatively, other loads including other types of musical staging backline with or without accessories.

2) The dolly of claim 1 whereby said extending beam is pivotally coupled to a side or sides of support beam comprising an extendable beam pivotally coupled to at least one other beam comprising an adjustable beam section coupled pivotally to a side or sides of said support beam and at least one additional beam comprising an adjustable utility dolly structure.

3) The dolly of claim 1 whereby said clamping mechanism being removably coupled to said support beam, said clamping mechanism being repositionably coupled to said support beam along a generally vertical connecting member.

4) The dolly of claim 1 whereby said wheels mounted to freely swivel, have a braking mechanism coupled to at least one said wheel.

5) The dolly of claim 4 whereby said braking mechanism coupled to at least one said wheel, is actuated by a lever or other means to engage and release said braking mechanism.

6) A method for holding and carrying a single or double tiered X stand type keyboard stand and/or other loads including musical staging backline and/or accessories on an adjustable utility dolly structure, comprising the steps of:
a. providing said single or double tiered X stand type keyboard stand and/or other loads including musical staging backline and/or accessories and positioning them on said adjustable utility dolly structure, and
b. providing a means of increasing effective footprint size of adjustable dolly structure in a predetermined extended configuration and decreasing effective footprint size of said adjustable dolly structure in a predetermined retracted configuration by pivotally coupling an extendable and retractable center beam section between two support beam sections enabling said adjustable utility dolly structure to change configuration to safely and securely fit said single or double tiered X stand type keyboard stand and/or other loads including musical staging backline items and/or accessories on said adjustable utility dolly structure at varying footprint sizes, and
c. providing a means further including a clamping mechanism to hold said single or double tiered X stand type keyboard stand and/or other loads including musical staging backline items and/or accessories in place on said adjustable utility dolly structure, and
d. a means wherein said clamping mechanism is removable enabling said adjustable utility dolly structure increased range of functionality and adaptability, and
e. a means wherein said clamping mechanism is repositionable along a generally vertical part and wherein said clamping mechanism may be positioned near said adjustable utility dolly structure in a predetermined closed limit configuration, and positioned at a distance away from said adjustable utility dolly structure in a predetermined open limit configuration, enabling adjustment capabilities of said clamping mechanism in relation to said adjustable utility dolly structure, and
f. providing a means of attaching accessories thereon said adjustable utility dolly structure including holes and/or slots and/or weldments to said adjustable utility dolly structure, and
g. providing a means of mobility such as wheels attached to said adjustable utility dolly structure, and
h. providing a means of applying and releasing a braking mechanism coupled to at least one said wheel enabling a user to apply and release said braking mechanism as needed,
whereby utilizing said adjustable utility dolly structure in conjunction with said single or double tiered X stand type keyboard stand and/or other loads including musical staging backline items and/or accessories, a user will gain a new feature of mobility added to said single or double tiered X stand type keyboard stand and/or other loads including musical staging backline items and/or accessories, enabling said single or double tiered X stand type keyboard stand and/or other loads including musical staging backline items and/or accessories to safely, easily, and securely be moved as a unit, or individually, across a surface, and yet another newly added feature of inspiring new yet undiscovered uses of said single or double tiered X stand type keyboard stand and/or other loads including musical staging backline items and/or accessories by a user.
